(19) United States
(12) Patent Application Publication
(10) Pub. No.: US 2011/0154226 A1
(43) Pub. Date: Jun. 23, 2011

(54) CHIP MODEL OF AN EXTENSIBLE PLUG-IN ARCHITECTURE FOR ENTERPRISE MASHUPS

(75) Inventors: Jochen Guertler, Karlsruhe (DE); Hermann Burgmeier, Sunnyvale, CA (US); Matthias Kruse, Burlingame, CA (US); Lior Bar-On, Kfar Sava (IL)

(73) Assignee: SAP AG, Walldorf (DE)

(21) Appl. No.: 12/643,692

(22) Filed: Dec. 21, 2009

(51) Int. Cl. G06F 9/46; G06F 3/048

(52) U.S. Cl. 715/760; 719/328; 715/763

(57) ABSTRACT

The present disclosure involves systems, software, and computer implemented methods for providing an extensible plug-in architecture for enterprise mashup applications. One process includes operations for receiving a chip definition associated with a chip instance to be instantiated. The new chip instance is instantiated, with the chip instance being associated with a portion of user interface (UI) content. At least one extension is determined to be associated with the chip instance based on the received chip definition. The chip instance is provided access to at least one method associated with an implementation of the at least one extension. Further, communication between the chip instance and a runtime environment through the implemented methods of the at least one extension is enabled.

### TECHNICAL FIELD

The present disclosure relates to software, computer systems, and computer implemented methods for providing an extensible plug-in architecture for enterprise mashup applications.

### BACKGROUND

Certain applications can support mashup capabilities, permitting users to combine components of different applications onto one page or workspace. For example, a user may select a particular component of one application and insert the component into a second application, or into a portal connecting functionality from two or more different applications. The combined components can be called mashup components because the components are capable of being “mashed up,” or collected, in a customized arrangement on a page or workspace. The page typically has a layout used to define the visual order of “mashable” applications or components, along with other static and/or dynamic elements or other components. Further, data flows can be defined between mashable applications by connecting the inputs and outputs of the various applications.

In general, mashable applications are designed for use in mashup scenarios. Thus, mashable applications are typically and intentionally programmed to visually occupy only a portion of a user interface, because otherwise, there would be no remaining visual space available in the application's user interface (UI) to include multiple mashable components. For example, each mashable application, or component, may be associated with a defined size or portion for presenting the relevant UI on the primary page.

A number of applications currently use mashable applications and components to provide enhanced user interfaces and interaction, as well as to collect and present information from numerous sources onto a single screen or application. However, multiple different and proprietary UI technologies are used to create these mashable applications and link the various components. Typically, different content runs completely isolated from other content. “Isolated” may mean isolated in regard to the content's rendering (i.e., in a separate frame or UI component on the same page), as well as isolated in regard to the available communication and integration capabilities between various mashup applications and components. In other words, no single model or architecture is available to generally describe the communication capabilities of a single piece of content. Each different mashup solution and application may be based on different UI technologies, causing difficulty for providing users an extensible and easily adaptable mashup architecture.

### SUMMARY

The present disclosure involves systems, software, and computer implemented methods for providing an extensible plug-in architecture for enterprise mashup applications. One process includes operations for receiving a chip definition associated with a chip instance to be instantiated. The new chip instance is instantiated, with the chip instance being associated with a portion of user interface (UI) content. At least one extension is determined to be associated with the chip instance based on the received chip definition. The chip instance is provided access to at least one method associated with an implementation of the at least one extension. Further, communication between the chip instance and a runtime environment through the implemented methods of the at least one extension is enabled.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example configuration of an environment for enabling an extensible plug-in architecture for enterprise mashups within the context of the present disclosure.

FIG. 2A is a flow diagram of an example process of initializing and embedding a particular mashup component (or “chip instance”) into a user interface using an appropriate system, such as the system described in FIG. 1.

FIG. 2B is a flow chart of an example process for creating, defining, and maintaining a particular mashup component using an appropriate system, such as the system described in FIG. 1.

FIG. 3 is an example signaling and flow diagram illustrating operations associated with creating and instantiating a particular instance of a mashup component using an appropriate system, such as the system described in FIG. 1.

FIG. 4 is a block diagram illustrating an example configuration of a system and architecture for enabling an extensible plug-in architecture for enterprise mashups using an appropriate system, such as the system described in FIG. 1.

FIG. 5 is a block diagram illustrating an example of an expanded configuration of a environment and architecture for enabling an extensible plug-in architecture for enterprise mashups, including an adapter and the integration of external content, using an appropriate system, such as the system described in FIG. 1.

FIG. 6 is a general schematic diagram illustrating a system and operations performed during the lifecycle of a mashup component in an appropriate system, such as the system described in FIG. 1.

FIG. 7 is a block diagram illustrating an example of the interactions associated with a mashup component during runtime in an appropriate system, such as the system described in FIG. 1.

### DETAILED DESCRIPTION

This disclosure generally describes computer systems, software, and computer implemented methods for enabling an extensible plug-in architecture for chips, or components, within enterprise mashup applications, pages, and infrastructures. Particularly, the present disclosure provides an example architectural model (or “chip model”) that provides a mashup content model independent from a particular concrete platform and user interface (UI) technology. In other words, the architecture described herein allows for designers and users of mashup applications to create detailed mashup applications that include content and information from a plurality of publishers, locations, and applications, at least some of which are provided via different UI technologies, using a single, unified architecture that understands and interacts with various types of content, regardless of the content's native UI technology.

Still further, the example chip model described herein provides enhanced extensibility as compared to previous solutions. To do so, the chip model allows individual chips, or mashup components, to be associated with extensions, or services that provide certain functionality to chips. When a chip is originally defined, the chip may be associated with one or more extensions that are either mandatory or optional. When a particular chip is selected for instantiation within a particular use case, a chip runtime module (or component runtime) ensures that such extensions are available, and creates a new implementation or instance of the selected or identified chip. By defining the extensions associated with a particular chip prior to the implementation, the current chip model can identify, without additional user input, the extensions to be used by a particular chip instance. In that manner, adding a chip to a particular implementation allows the runtime to quickly and easily determine which extensions are required for a chip's implementation. Thus, using a type of dependency injection, the particular extensions within the implementation can keep track of which chips and components have used a particular extension or the functionality associated with that extension. Further, chips and components using a particular extension are provided a means for communication, thereby allowing chips and components from a plurality of sources to communicate via common extensions.

One of the primary advantages of the described chip model is the strict separation between the chip model itself and any potential implementation using elements from the chip model. The chip model does not define the underlying platform or UI technology used to run or build particular chips—instead, the chip model merely defines the contracts and requirements that a particular chip must fulfill. Thereby, a particular implementation of a chip can be run on any capable platform or UI technology so long as the contracts required by the chip are met. In some instances, these contracts are defined by particular extensions that must be available to a chip in order for the chip to be implemented.

A number of additional advantages are provided by the described chip model over existing frameworks used to build enterprise mashup scenarios and applications. First, the metadata for a particular chip and a particular chip implementation are available separately in the chip model. Thus, the chip (or component) runtime can use the chip metadata to determine suitable extensions without having to instantiate the chip implementation. In other words, a particular implementation can be developed with knowledge of extensions necessary for the chip to perform its required actions, allowing multiple developers to create various implementations based on the predefined information defined by the chip's metadata. Further, extensions are able to supply a customized service implementation based on the specific information defined in the chip metadata. Thus, specialized service implementations (as opposed to generic implementations) may be developed for the specific chips those service implementations will be servicing. Still further, particular extensions themselves may be chips and can further participate as service clients similar to normal chips. In other words, a dependency network of chips and service extensions can be built inside the chip (or component) runtime that may allow the dynamic enablement and disablement of extensions. Thus, the presently described chip model and related methods allow developers the freedom to design and create unique and individualized mashup scenarios, using highly extensible components, without requiring the use of a particular platform or UI technology. These advantages allow particular instances of the various chips and extensions defined by a broad range of entities to be reused in multiple implementations based upon the particular tools (i.e., platforms and UI technologies) available to the developer. As such, the extensibility of the described architecture provides numerous advantages to both developers and customers alike.

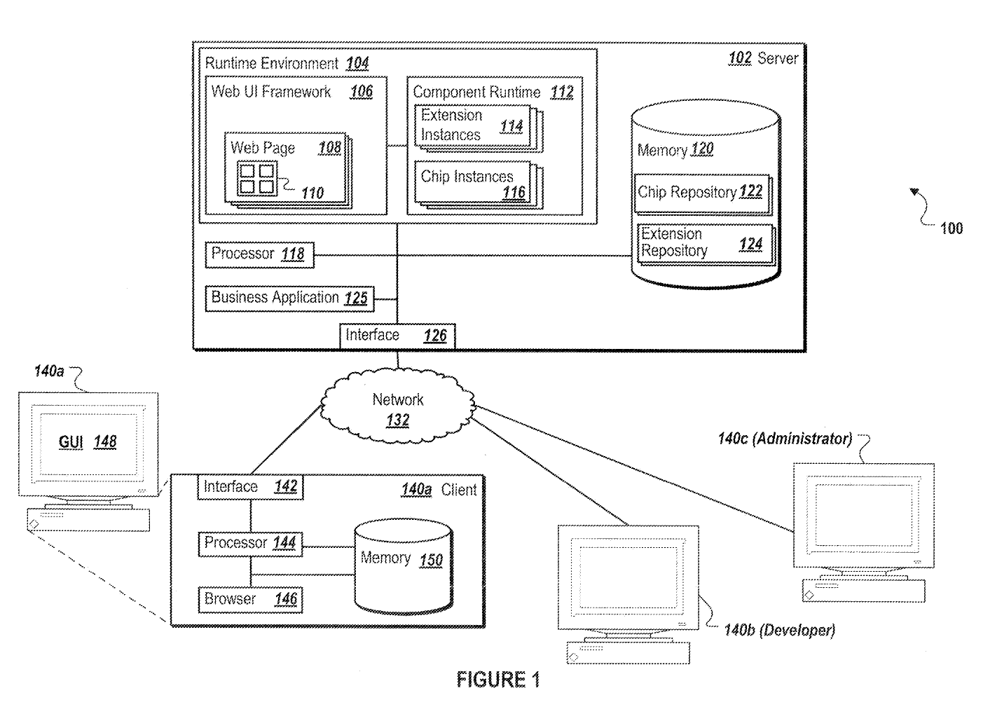

Turning to the illustrated example, FIG. 1 illustrates an example environment 100 for enabling an extensible plug-in architecture for enterprise mashups. The illustrated environment 100 includes or is communicably coupled with server 102 and one or more clients 140, at least some of which communicate across network 132. In general, environment 100 depicts an example configuration of a system capable of providing and creating multiple mashup applications or scenarios in one or more underlying technologies, thus providing developers and users with the freedom to create individualized solutions through a common chip architecture.

In general, server 102 is any server that stores and/or executes one or more runtime environments 104 and business applications 125, where at least a portion of the operations performed on the server 102 are executed via requests and responses sent to users or clients within and communicably coupled to the illustrated environment 100 of FIG. 1. For example, server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 102 may store a plurality of various business applications 125 and runtime environments 104, while in other instances, the server 102 may be a dedicated server meant to store and execute only a single business application 125. In some instances, the server 102 may comprise a web server, where the business application 125 represents a web-based application accessed and executed via network 132 by the clients 140 of the system to perform the programmed tasks or operations associated with the business application 125 or runtime environment 104.

At a high level, the server 102 comprises an electronic computing device operable to receive, transmit, process, store, or manage data and information associated with the environment 100. The server 102 illustrated in FIG. 1 can be responsible for receiving application requests from one or more client applications or web browsers 146 associated with the clients 140 of environment 100 and for responding to the received requests by processing said requests in the associated business application 125 or runtime environment 104, and sending the appropriate response from the corresponding entity back to the requesting client application or browser 146. Alternatively, the business application 125 and runtime environment 104 at server 102 can be capable of processing and responding to local requests from a user accessing server 102 locally. Accordingly, in addition to requests from the external clients 140 illustrated in FIG. 1, requests associated with the business application 125 or runtime environment 104 may also be sent from internal users, external or third-party customers, or other automated applications, as well as any other appropriate entities, individuals, systems, or computers.

As used in the present disclosure, the term “computer” is intended to encompass any suitable processing device. For example, although FIG. 1 illustrates a single server 102, environment 100 can be implemented using two or more servers 102, as well as computers other than servers, including a server pool. Indeed, server 102 may be any computer or processing device such as, for example, a blade server, a general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any suitable operating system, including Linux, UNIX, Windows, Mac OS X, as well as others. According to one embodiment, server 102 may also include or be communicably coupled with a mail server.

In the present implementation, and as shown in FIG. 1, the server 102 includes a processor 118, an interface 126, a memory 120, a runtime environment 104, and a business application 125. The interface 126 is used by the server 102 for communicating with other systems in a client-server or other distributed environment (including within environment 100) connected to the network 132 (e.g., client 140a, as well as other systems communicably coupled to the network 132). Generally, the interface 126 comprises logic encoded in software and/or hardware in a suitable combination operable to communicate with the network 132. More specifically, interface 126 may comprise software supporting one or more communication protocols such that the network 132 or interface hardware is operable to communicate physical signals within and outside of the illustrated environment 100.

Server 102 includes the processor 118. Although illustrated as a single processor 118 in FIG. 1, two or more processors may be used according to particular needs, desires, or particular embodiments or implementations of environment 100. Each processor 118 may be a central processing unit (CPU), a blade, an application specific integrated circuit (ASIC), a field-programmable gate array (FPGA), or another suitable component. Generally, the process 118 executes instructions and manipulates data to perform the operations of server 102 and, as illustrated in FIG. 1, the runtime environment 104 and a business application 125. Specifically, the server's processor 118 executes the functionality required to receive and respond to requests from the clients 140 and their respective client applications or browsers 146, as well as the functionality required to perform the other operations associated with the runtime environment 104 and the business application 125.

Regardless of the particular implementation, “software” may include computer-readable instructions, firmware, wired or programmed hardware, or any combination thereof on a tangible medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, processor 118 executes the runtime environment 104 and a business application 125 on the server 102.

The runtime environment 104 comprises a collection of software services available to the server 102 during its execution. The particular services included within the runtime environment 104 may be provided by the operating system or another application running on the server, such as business application 125. Specifically, the runtime environment 104 supports the execution of a web UI framework 106 and a component runtime 112 operable to implement the extensible chip model described herein. In some instances, the runtime environment 104 may be a J2EE environment, itself supported by the server 102, in which various development and implementation operations associated with the current disclosure are performed.

The component runtime 112 within the overall runtime environment 104 is a runtime environment for executing one or more chips, or mashup components. Several definitions are helpful to discuss the items associated with the component runtime 112. First, a chip is an executable piece of software that adheres to the chip model described herein, and that runs within the component runtime 112. A particular chip may be created and or maintained in a chip development environment (not illustrated).

A chip definition is a metadata structure describing an implementation of a chip. In FIG. 1, the chip definition is stored within the chip component repository 122 of memory 120. One particular implementation of a chip can be used by several chip definitions. Additionally, the implementation of a particular chip can behave differently when started using a different chip definition. The chip definition is generally only loosely coupled to the chip implementation, and is generally available and accessible without having to start a particular implementation of the chip.

A chip instance 116 represents an instantiated instance of a chip definition. In some embodiments, there can be several instances 116 of the same chip definition. In those instances, each particular chip instance can be distinguished by a unique chip instance identifier, thus allowing the component runtime 112 to differentiate and address particular chip instances when necessary.

Extensions provide implementations for particular contracts describing one or more services exposed to, and providing certain functionality, to one or more chips (or chip instances 116). A chip declares in its chip definition one or more extensions to be used upon the chip's instantiation. Extensions for a particular chip may be listed as mandatory or optional. If one of the mandatory extensions defined for a particular chip is unavailable, the component runtime 112 will generally not allow a chip instance to be instantiated. As illustrated in FIG. 1, extension instances 114 associated with one or more of the chip instances 116 are executed by the component runtime 112. In alternative implementations, however, the extension instances 114 may also be executed separately from the component runtime 112, such that the component runtime 112 allows for interaction between the running chip instances 116 and one or more external extension instances 114 executing or located external to component runtime 112, the runtime environment 104, and/or the server 102. Further, one or more extensions may be stored local to server 102, such as in an extension repository 124 as illustrated in memory 120. This extension repository 124 may store one or more extensions associated with the various chips stored within the chip repository 122, as well as other extensions related to chips located outside of server 102, but communicably coupled to the server 102. In some instances, the extension repository may be a repository for all components associated with the runtime environment 104, including components other than those used specifically with the component runtime 112. In those instances, the extension repository 124 may be a smaller portion of a larger repository storing additional components.

Returning to the component runtime 112, the component runtime 112 may analyze a particular chip's definition metadata stored with a particular (or identified) chip in the chip repository 122 of memory 120. As described above, the metadata for each chip provides a description of one or more extensions required by the chip instance 116 to perform its particular functionality. Additionally, the chip definition metadata may identify one or more optional extensions that, in some instances, may be used by the instantiated component chip instance 116, but that are not required for the component instance's basic functionality.

Once the component runtime 112 identifies the required (and in some cases, optional) extensions for a particular chip, the component runtime 112 can locate, retrieve, and/or associate the relevant extension (via the illustrated extension instance 114) with the instantiated chip instance 116. In some instances, the extension instances 114 may be executed within the component runtime 112, while in others, the extension instances 114 may be executed outside the component runtime 112 and/or the runtime environment 104.

As illustrated, the component runtime 112 can instantiate a plurality of chip instances 116. Each chip instance 116 may be associated with one or more web pages 108 or other web-based applications or documents included within the web UI framework 106. The web UI framework 106, also included within the runtime environment 104 and executed by the processor 118, may generally be any application, program, module, process, runtime engine, or other software that may execute, change, delete, generate, or otherwise manage information according to the present disclosure, particularly in order to implement the visual representations of data or content associated with one or more of the chip instances 116. The web UI framework 106 is separate from the component runtime 112, allowing the running chip instances 116 to provide content and data to an independent web page 108 or web-based application In general, one or more clients 140, using associated web browsers 146 or other client applications, may interact with the web UI framework 106 to view the one or more web pages 108 or web-based applications associated therewith. In each web page 108, the visual representation of the content supplied by each chip instance 116 is visible to and viewable by the client 140. In some instances, the web UI framework 106 may be closely associated with the business application 125, such that the web UI framework 106 is a portion or component of the business application 125. In other instances, the business application 125 may be communicably coupled to the web UI framework 106, allowing the business application 125 to access and take advantage of the functionality provided by the web UI framework 106. The functionality provided by the UI framework 106 can include providing UI support for development of web pages 108, web representations of the business application 125, as well as other suitable functionality. For example, developers may use the web UI framework 106 to create one or more web pages 108 using one or more chips from the chip repository 122. The web UI framework 106 may possess the functionality allowing the developer to manipulate the layout, operations, and relationships of one or more chips 110 within a web page 108 or other web-based application. Still further, the web UI framework 106 can be used to develop one or more user interfaces or other visual representations associated with the business application 125. By combining multiple chips into the design, developers can create mashup scenarios and applications using the web UI framework 106, and execute said scenarios and applications with the component runtime 112 when the particular pages or applications are executed.

At a high level, the business application 125 is any application, program, module, process, or other software that may execute, change, delete, generate, or otherwise manage information according to the present disclosure, particularly in response to and in connection with one or more requests received from the illustrated clients 140 and their associated web browsers 146 or other client applications. In certain cases, such as that illustrated in FIG. 1, only one business application 125 may be located at a particular server 102. In others, a plurality of related and/or unrelated business applications 125 may be stored at a single server 102, or located across a plurality of other servers 102, as well. In certain cases, environment 100 may implement a composite business application 125. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the business application 125 may represent a web-based application accessed and executed by remote clients 140 or client applications (such as the client's browsers 146) via the network 132 (e.g., through the Internet). Further, while illustrated as internal to server 102, one or more processes associated with a particular business application 125 may be stored, referenced, or executed remotely. For example, a portion of a particular business application 125 may be a web service associated with the application that is remotely called, while another portion of the business application 125 may be an interface object or agent bundled for processing at a remote client 140. Moreover, the business application 125 may be a child or sub-module of another software module or enterprise application (not illustrated) without departing from the scope of this disclosure. Still further, portions of the hosted application 125 may be executed by a user working directly at server 102, as well as remotely at client 140. In general, the business application 125 may be any software capable of integrating a mashup scenario or application defined within the web UI framework 106, and executed via the component runtime 112.

As previously referenced, the server 102 also includes memory 120. The memory 120 of the server 102 may include any memory or database module and may take the form of volatile or non-volatile memory including, without limitation, magnetic media, optical media, random access memory (RAM), read-only memory (ROM), removable media, or any other suitable local or remote memory component. For example, memory 120 may store indexes, classes, applications, chips, extensions, backup data, jobs, parameters, cookies, variables, algorithms, instructions, rules, or references thereto.

For example, illustrated memory 120 includes the previously referenced chip repository 122 and the extension repository 124. Although illustrated within memory 120, some or all of these elements may be located external to memory 120 and/or server 102 in certain implementations (e.g., in multiple different memories or multiple different servers, such as additional or alternative repositories stored at other servers or locations communicably coupled to server 102). In the present example of environment 100, the chip repository 122 is a repository for storing chip definitions. In some instances, the chip repository 122 may also store particular chip implementations as well, such as those commonly used for particular technologies associated with server 102. As previously described, the chip definition is a metadata representation of chip information, including a listing or set of the extensions (or services) associated with a particular chip, as well as a list of which of those extensions are required for the chip. In general, these chip definitions are provided as extensible markup language (XML) documents containing information regarding the associated chip. Additionally, some chip definition metadata documents may include configuration sheets to allow for advanced and diverse chips. The properties of a particular configuration sheet can be deployed with the metadata or created and/or adjusted by a user or client prior to use. The configuration parameters included in the configuration sheets can be expressed within an XML structure or as name-value pairs, as well as in any other appropriate form. Additionally, specific changes to the configuration parameters may be used when requesting the component runtime 112 to initialize a particular chip instance 116 for a defined purpose, such as by manipulating the format or visualization information listed within the chip definition, as well as by tweaking or changing other properties associated with the chip's particular performance or activities. In some instances, such as to support rapid chip development, a chip can be implemented or defined as a generic chip, where the particular behavior associated with the chip is controlled by the settings within the chip's configuration sheet. This generic chip allows a customization of the chip and chip behavior without requiring a full cycle development process. Instead, a key user or client can make changes directly within the system allowing for flexible deployment options for the chip metadata. Still further, modified chips and chip definitions may in some cases be distributed to other users and/or systems, with the modified chip definitions added to the chip repository 122 for future use.

Additionally, memory 120 is illustrated as including the extension repository 124. The extension repository 124 may include one or more extensions relevant to the chip definitions stored in the chip repository 122, as well as extensions related to chips located outside of the chip repository 122. In general, the extensions of the extension repository 124 provide the component runtime 112 quick or immediate access to one or more extensions required for chip instances 116 at instantiation. Alternatively, the component runtime 112 may search for required extensions via network 132, or locate particular extensions based on information included with the chip definition of a particular chip instance 116. In some instances, server 102 may not include a chip repository 122 and/or extension repository, such that the server 102 retrieves the necessary and optional elements and components from other locations.

Generally, server 102 may be communicably coupled with a network 132 that facilitates wireless or wireline communications between the components of the environment 100 (i.e., between the server 102 and the clients 140), as well as with any other local or remote computer, such as additional clients, servers, or other devices communicably coupled to network 132 but not illustrated in FIG. 1. The network 132 is illustrated as a single network in FIG. 1, but may be a continuous or discontinuous network without departing from the scope of this disclosure, so long as at least a portion of the network 132 may facilitate communications between senders and recipients. The network 132 may be all or a portion of an enterprise or secured network, while in another instance at least a portion of the network 132 may represent a connection to the Internet. In some instances, a portion of the network 132 may be a virtual private network (VPN), such as, for example, the connection between the client 140 and the server 102. Further, all or a portion of the network 132 can comprise either a wireline or wireless link. Example wireless links may include 802.11a/b/g/n, 802.20, WiMax, and/or any other appropriate wireless link. In other words, the network 132 encompasses any internal or external network, networks, sub-network, or combination thereof operable to facilitate communications between various computing components inside and outside the illustrated environment 100. The network 132 may communicate, for example, Internet Protocol (IP) packets, Frame Relay frames, Asynchronous Transfer Mode (ATM) cells, voice, video, data, and other suitable information between network addresses. The network 132 may also include one or more local area networks (LANs), radio access networks (RANs), metropolitan area networks (MANs), wide area networks (WANs), all or a portion of the Internet, and/or any other communication system or systems at one or more locations. The network 132, however, is not a required component of the present disclosure.

The illustrated environment of FIG. 1 also includes one or more clients 140. Each client 140 may be any computing device operable to connect to or communicate with at least the server 102 and/or via the network 132 using a wireline or wireless connection. Further, as illustrated by client 140a, each client 140 includes a processor 144, an interface 142, a graphical user interface (GUI) 148, a browser (or client application) 146, and a memory 150. In general, each client 140 comprises an electronic computer device operable to receive, transmit, process, and store any appropriate data associated with the environment 100 of FIG. 1. It will be understood that there may be any number of clients 140 associated with, or external to, environment 100. For example, while illustrated environment 100 includes three clients (140a, 140b, and 140c), alternative implementations of environment 100 may include a single client 140 communicably coupled to the server 102, or any other number suitable to the purposes of the environment 100. Additionally, there may also be one or more additional clients 140 external to the illustrated portion of environment 100 that are capable of interacting with the environment 100 via the network 132. Further, the term “client” and “user” may be used interchangeably as appropriate without departing from the scope of this disclosure. Moreover, while each client 140 is described in terms of being used by a single user, this disclosure contemplates that many users may use one computer, or that one user may use multiple computers.

As used in this disclosure, client 140 is intended to encompass a personal computer, touch screen terminal, workstation, network computer, kiosk, wireless data port, smart phone, personal data assistant (PDA), one or more processors within these or other devices, or any other suitable processing device. For example, each client 140 may comprise a computer that includes an input device, such as a keypad, touch screen, mouse, or other device that can accept user information, and an output device that conveys information associated with the operation of the server 102 (and business application 125) or the client 140 itself, including digital data, visual information, the browser 146, or the GUI 148. Both the input and output device may include fixed or removable storage media such as a magnetic storage media, CD-ROM, or other suitable media to both receive input from and provide output to users of the clients 140 through the display, namely, the GUI 148.

As indicated in FIG. 1, client 140b may be specifically associated with a developer of web UI framework 106, the component runtime 112, the business application 125, and/or chips and extensions associated with environment 100. For example, the developer 140b may access the web UI framework 106 to manipulate or design one or more web pages 108 incorporating the functionality and visualization of one or more chip instances 116, as well as particular visual interfaces for the business application 125. Further, the developer 140b may create new chips and extensions to be stored in the chip repository 122 or extension repository 124, respectively. In the present disclosure, the terms “developer” and “end user” may be used interchangeably as appropriate without departing from the scope of this disclosure.

Further, client 140c is specifically associated with an administrator of the illustrated environment 100. The administrator 140c can modify various settings associated with one or more of the other clients 140, the server 102, the business application 125, the web UI framework 106, the component runtime 112, and/or the runtime environment 104 in general, as well as any relevant portion of environment 100. For example, the administrator 140c may be able to modify the relevant timeout values associated with chip instances 116 of the component runtime 112, various parameters associated with the business application 125, as well as any other relevant settings associated with environment 100. The administrator of the illustrated environment may also execute changes to server 102 directly at the server 102. In the present disclosure, the terms “administrator” and “end user” may be used interchangeably as appropriate without departing from the scope of this disclosure.

The interface 142, processor 144, and memory 150 of each client 140 may be similar to the interface 126, processor 118, and memory 120 of the server 102. The GUI 148 of client 140 comprises a graphical user interface operable to allow the user to interface with at least a portion of environment 100 for any suitable purpose, including generating a visual representation of the web pages 108 or the visual interfaces associated with the business application 125. Generally, the GUI 148 provides users with an efficient and user-friendly presentation of data provided by or communicated within the system. The term “graphical user interface,” or GUI, may be used in the singular or in the plural to describe one or more graphical user interfaces and each of the displays of a particular graphical user interface. Therefore, the GUI 148 can be any graphical user interface, such as a web browser, touch screen, or command line interface (CLI) that processes information in the environment 100 and efficiently presents the results to the user. In general, the GUI 148 may include a plurality of user interface (UI) elements such as interactive fields, pull-down lists, and buttons operable by the user at the client 140. These UI elements may be related to the functions of one or more applications executing at the client 140, such as the business application 125 or the web browser 146 associated with the GUI 148. In particular, the GUI 148 may be used in connection with the web browser 146 associated with the GUI 148 to view and navigate to various web pages 108, some of which may be associated with (or the visual representation of) the plurality of web pages 108. For purposes of the present disclosure, the terms “web browser” and “GUI” may be used interchangeably, such that the GUI 148 may be referred to as the “web browser 146.”

In some instances, the GUI 148 (or the web browser 146) is a software application which enables the client 140 (or a user thereof) to display and interact with text, images, videos, music, and other multimedia files and information typically located in web pages or web-based applications located at the server 102, or other computers accessible via the network 132. Additionally, the GUI 148 (or web browser 146) allows the client 140 to present the visualization of the various mashup scenarios and applications generated by the web UI framework and component runtime 112. Text and images embedded within web pages displayed by the web browser 146 can contain the content generated by the plurality of chip instances 116 executed by the component runtime 112 in a format defined by the web UI framework 106 and its associated functionality. Additionally, the web browser 146 may allow the client 140 to interact with various UIs and screens presented in association with the business application 125, such that one or more enterprise mashup applications can be accessed, interacted with, and manipulated using the GUI 148 and the browser 146. Example web browsers 146 may include Microsoft's Internet Explorer, Mozilla's Firefox, Apple's Safari, Opera Software ASA's Opera browser, and Google's Chrome, as well as any other suitable browser. In certain implementations, the web browser 146 may be associated with, or may be a portion or module of, the business application 125, which provides web-based functionality at the client 140 to interact with the business application 125 and its related operations.

While FIG. 1 is described as containing or being associated with a plurality of elements, not all elements illustrated within environment 100 of FIG. 1 may be utilized in each alternative implementation of the present disclosure. For example, although FIG. 1 depicts a server-client environment implementing a business application 125 and runtime environment 104 at server 102 that can be accessed by a client 140, in some implementations, server 102 executes a local application that features an application UI accessible to a user directly utilizing GUI 148 to interact with the elements illustrated within the server 102. Additionally, one or more of the elements described herein may be located external to environment 100, while in other instances, certain elements may be included within, or as a portion of, one or more of the other described elements, as well as other elements not described in the illustrated implementation. Further, certain elements illustrated in FIG. 1 may be combined with other components, as well as used for alternative or additional purposes in addition to those purposes described herein.

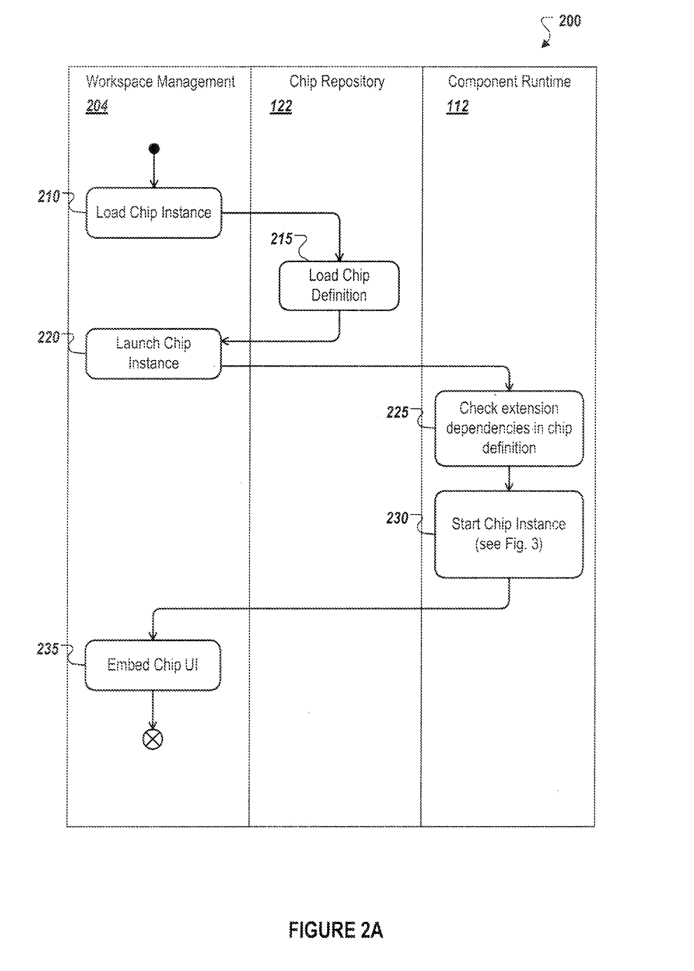

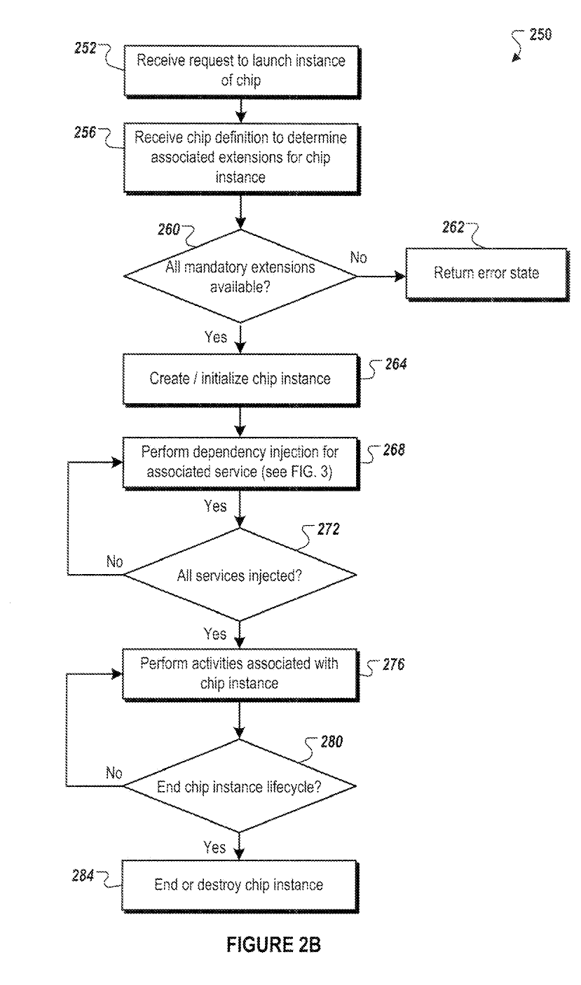

FIG. 2A illustrates a flow diagram of an example process of initializing and embedding a particular chip instance as described in the present disclosure. As illustrated three components, including two illustrated in FIG. 1, are involved in method 200. Those three components are a workspace management component 204, the chip repository 122, and the component runtime 112. The workspace management component 204 comprises a portion of the web UI framework 106 that allows a developer to format, organize, and develop one or more mashup applications or scenarios using the chips stored in the chip repository 122 or elsewhere. In other words, developers may use the workspace management component 204 of the web UI framework 106 to define one or more web pages or web-based applications that take advantage of the extensible plug-in architecture described in the present disclosure.

At 210, an end user interacting with the workspace management component 204 of the web UI framework 106 designs a portion of a mashup application by adding a chip to the particular web page (or other web-based application screen). Adding the chip instance at 210 may comprise the end user searching the chip repository 122 for a particular chip, such as a listing of chip names in a side bar or other UI element of the web UI framework 106. In some instances, the end user may drag and drop a particular chip name from a menu onto the web page layout screen associated with the workspace management component 204 to indicate that the particular chip should be loaded to the page at a particular location. In some instances, each new chip added to a page may be initially located in a default position, such as the next available space in a grid-based development area.

Once a particular chip is identified and the end user requests that a corresponding chip instance be loaded, at 215 the chip definition (or chip metadata) is retrieved from the chip repository 122. In some instances, several variations on a particular chip may be available in the chip repository 122, and loading a particular chip definition may include the end user selecting one of a plurality of related chip definitions. Alternatively, one or more configuration parameters may be specified from various options or selections associated with the chip definition to be loaded. For example, a name or title associated with the newly-selected chip instance may be prompted for the end user to enter at this point, as well as other options determining how the particular chip instance will operate. In still another implementation, the chip definition may be loaded with a default configuration at 215, but allow the end user to update said definition prior to launching the chip instance.

Once the chip definition is loaded, the workspace management component 204 launches the chip instance at 220. Launching the chip instance may include providing some command or other indication to the component runtime 112 that a new chip instance is being launched within the web UI framework 106. In some examples, loading the chip definition (215) and launching the chip instance (220) may occur immediately after the loading the chip instance step of 210, such as without further developer or user action. In other instances, the step of launching the chip instance (220) may require explicit user input, such as a mouse-click or other confirmation indicating that the location and/or configuration parameters for the chip instance are ready for instantiation.

At 225, the component runtime 112 receives the indication to launch the chip instance from the workspace management component 204 and begins its initialization and instantiation of the chip instance. Specifically, at 225 the component runtime 112 checks the one or more extension dependencies included within the chip definition. In other words, the component runtime 112 determines whether each of the mandatory extensions defined in the chip definition are available for connection to the requested chip instance. Generally, if a mandatory extension is unavailable, the component runtime 112 will return an error and not load or instantiate the chip instance. Alternatively, the component runtime 112 may offer the developer or workspace management component 204 the opportunity to locate the missing mandatory extension, as well as modify the chip metadata to reflect a different or alternative extension that may be used instead. Additionally, the component runtime 112 may determine whether each of the optional extensions are available. If one or more optional extensions are not available, the component runtime 112 ignores the optional requests for extensions that cannot be fulfilled. As long as the mandatory extensions are available, the component runtime 112 will continue without notifying the developer/workspace management component 204, although in some instances, a notification that certain optional extensions are unavailable may be presented.

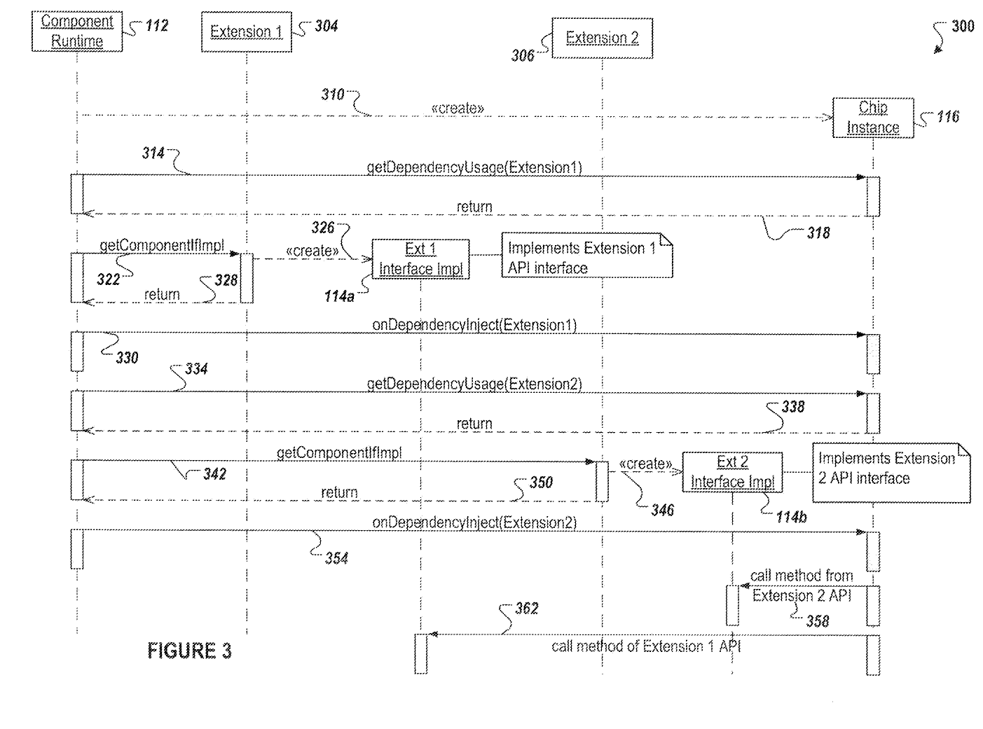

Once the extension dependencies have been checked and each mandatory extension is located or identified as available, the component runtime 112 starts the chip instance. As the component runtime 112 manages the lifecycle of each chip instance it launches, starting the chip instance may include any number of steps to fulfill and perform said lifecycle management. As illustrated in FIG. 3, the component runtime 112 may perform a dependency injection with each identified extension to provide the chip instance with the connections and wirings necessary to perform the extensions' services and functionality. Additionally, once the chip instance is started at 230 and the appropriate connections to the one or more extensions have been created, communications from chip instance to extension and from extension to chip instance can be initiated.

At 235, the workspace management component 204 (or web UI framework 106) may receive confirmation that the component runtime 112 has initiated the chip instance identified in 210, and can then embed the chip instance's associated UI content into the related web page or web-based application screen as initially intended. In some instances, prior to embedding the chip instance's UI content or data, the location of the chip instance will be identified by a placeholder or other demarcation on the workspace management component's 204 visualization or UI. Once the chip instance has been loaded and started by the component runtime 112, the appropriate UI elements and content provided by the chip instance can be embedded in, or viewable on, the web page or web-based application.

As a simple example, the particular chip instance loaded at 210 may comprise a weather application for displaying the current temperature. When the chip definition is loaded from the chip repository 122 at 210, several variations of a single weather application chip may be available, and a particular version selected. Once the location of the chip instance is identified, and any relevant confirmation parameters or information provided (in this case, possibly a zip code or city name), the chip instance is launched by the workspace management component 204 at 220. At 225, the component runtime 112 may determine what extension dependencies are defined in the chip definition for the weather application. In some instances, this may be an extension capable of retrieving or exchanging information with a weather-based website, such as weather.com or another suitable site. If that extension is located and determined to be available, at 230 an instance of the weather chip is started. At 235, the visual representation, or chip UI, associated with the chip instance is embedded into the web page or web-based application at the workspace management component 204 of the web UI framework 106. The developer or user can continue and add additional chip instances to the web page or web-based application, as well as publish the particular web page or web-based application for consumption by end users.

FIG. 2B is a flow chart illustrating the lifecycle management and other chip instance-related processes associated with the component runtime. For clarity of presentation, the description of method 250 references environment 100 illustrated in FIG. 1, using example elements that may perform one or more of the described operations. However, it will be understood that method 250 may be performed, for example, by any other suitable system, environment, or combination of systems and environments as appropriate.

At 252, the component runtime receives a request to launch a particular chip instance. As illustrated in FIG. 2A, this request may come from the workspace management component 204. Additionally, the request may be received from a user associated with a particular web page or application, including business application 125 of FIG. 1.

Method 250 continues at 256 where the component runtime receives the chip definition (e.g., a chip instance's defined metadata) associated with the requested chip instance in order to determine the associated extensions defined for the chip instance. In some instances, receiving the chip definition may comprise the component runtime actively locating and retrieving the chip definition associated with the requested chip instance from the chip repository (e.g., chip repository 122 of FIG. 1). In other instances, another component, such as chip launcher or other retrieval component, may identify and provide the proper chip definition to the component runtime. As previously described, the chip definition includes various chip-related information, including the one or more mandatory (and optional) extensions associated with the chip. These extensions provide the chip instance with its functionality, including the chip instance's basic functionality required to perform its most basic tasks.

At 260, the component runtime determines whether all of the mandatory extensions are available to the component runtime. Determining whether the mandatory extensions are available may comprise searching a local repository for the named or identified extensions, as well as searching one or more external or remote repositories for the mandatory extensions. Additionally, the determination step of 260 may not only search for the mandatory extensions, but also return an instance of the relevant extension to the component runtime for use with an instantiated chip instance. In some instances, the component runtime may interface or correspond with a directory service or other component capable of locating one or more chip-related extensions to find the location and availability of a particular extension. Additionally, the component runtime may check a table, database, or other list to determine whether or not the mandatory extensions are known to, or accessible by, the component runtime without actually retrieving the identified extensions. This may save time for chip definitions where a relatively high number of extensions are mandatory, as the component runtime can quickly determine whether or not each of the extensions is available simply by searching a single location or file. The extensions themselves can be retrieved from their appropriate locations at this time, or during the dependency injection step of 268.

If it is determined that not all mandatory extensions from a particular chip definition are available, method 250 moves to 262 where an error state is returned, and the component runtime ends its attempt to instantiate the requested chip instance. In some instances, the component runtime may attempt to locate an alternative extension comparable or related to the functionality presented by the missing mandatory extension in order to continue with the chip instance instantiation, either by searching alternative repositories itself, requesting a developer or user to modify the extension requested, or by comparing the functionality intended by the mandatory extension with functionality provided by other extensions. If an interchangeable extension is identified, method 250 may end the error state and return to 264. If, however, all mandatory extensions are identified as expected, method 250 continues to 264. At 264, the component runtime (e.g., component runtime 112 of FIG. 1) creates, or initializes, a chip instance associated with the requested chip. In some instances, this initialization step may merely be the generation of a placeholder or temporary object for the chip instance. Specifically, the chip instance at 256 is initialized to prepare for the creation of the actual chip instance later in the process. Additionally, it should be noted that one reason that chip definitions and chip implementations are separate entities is to allow the component runtime to check the dependencies for availability prior to instantiating the chip instance. In instances where mandatory dependencies are unavailable, no unnecessary memory is used to instantiate a chip instance that will later be unable to perform its basic functionality.

At 268, the component runtime performs dependency injection operations for a first extension (either mandatory or optional) identified in the chip definition. Dependency injection is the process where each of the extensions is connected to the created chip instance, thus allowing the functionality associated with the chip instance to be realized in the component runtime. A number of operations are performed, with one example illustrated in FIG. 3 and described in the associated text. As an overview for purposes of the description of method 250, the component runtime identifies the location or address of the relevant extension and queries said extension for the correct service implementation. Once identified, those service implementations are injected into the created chip instance to provide for communication between the chip instance and the relevant extensions. In one example, the chip instance consumes an application programming interface (API) associated with the relevant extension in order to allow the chip instance to call at least a subset of the operations associated with the extension. Once the dependency is injected into the chip instance, the chip instance will be able to perform the services and operations defined and represented by the appropriate extensions.

At step 272, the component runtime determines whether all extensions listed in the chip instance have been injected. If they have, method 250 continues at 276. If it is determined that additional extensions must be injected into the chip instance, method 250 returns to 268 and continues the dependency injection operations. This process loops until all mandatory extensions are injected into the chip instance. In some instances, one or more optional extensions may not be available or cannot be injected. In those instances, the component runtime would continue through the list of extensions, ignore the missing optional extension, and continue with the instantiation of the chip instance. If, however, the injection of a mandatory extension is unsuccessful, method 250 may continue as if the determination at 264 had been that all mandatory extensions were not available, and move method 250 to 284 where the chip instance is destroyed before completing the dependency injection phase.

At 276, the component runtime performs the relevant activities associated with the current chip instance. Returning to the weather chip example, certain weather information, data, and content may be presented through the connections provided by the component runtime. Additionally, communications between the present chip instance and other chip instances in the same web page or web-based application may occur through the exchange of messages by the component runtime, or through extensions shared by one or more of the components. At this point, the chip instance is free to provide its content to users and others interacting with the web page or web-based application in which the associated chip UI is embedded. At 280, the component runtime determines whether the chip instance lifecycle is to end. This determination may be based on one or more suitable factors, including whether the web page or web-based application associated with the chip instance has completed its processing or its actions, whether the chip instance is no longer relevant to the particular implementation, or whether the chip instance is specifically requested to be removed or closed, among others. In any event, if it is determined that the chip instance's lifecycle is to continue, method 250 returns to 276 to perform the normal activities of the chip instance. If the lifecycle is determined to be complete or ready to end, at 284 the component runtime ends and/or destroys the particular chip instance. In some examples, ending the chip instance may comprise stopping the chip instance, but not destroying it. In other words, the chip instance may be turned off, or disconnected from its extensions, such that it cannot perform its normal functionality. In other instances, the chip instance may be removed from the web page or web-based application with which it is associated.

FIG. 3 is an example signaling and flow diagram providing the operations associated with an example dependency injection, such as the dependency injection referenced in both FIGS. 2A and 2B. The chip instance 116, for which the dependency injection of diagram 300 is shown, is associated with two different extensions, extension 1 (304) and extension 2 (306). This may mean that the chip definition metadata for this particular chip instance 116 only included two extensions, or that only two extensions included with the chip definition were available. As previously noted, if the chip definition defined any mandatory extensions, they are included in the present diagram 300, or the chip instance would not be started and the dependency injection of FIG. 3 would not occur.

Beginning at 310, component runtime 112 creates a new chip instance 116. In general, the component runtime 112 will have already retrieved the chip definition from the chip repository prior to creating the chip instance 116 and know which extensions this particular chip instance wants to use. In some instances, however, the component runtime 112 may create a placeholder for the chip instance 116 prior to determining the particular extensions to be used. In some instances, the component runtime 112 may create or store the list of extensions associated with the chip instance 116. Once the chip instance 116 is created, the component runtime 112 then loops over the list of extensions one by one (or in some cases, concurrently) to create the dependencies on each of the relevant extensions.

At 314, the component runtime 112 calls the getDependencyUsage( ) method to the chip instance 116. The getDependencyUsage( ) call includes the parameter “Extension 1,” or the first extension included in the list of extension dependencies included in the chip definition metadata. In response to the call, the chip instance 116 provides a pointer or connection point for where Extension 1 (304) will be injected into the chip instance 116. In some instances, the chip instance 116 returns what is considered a “component usage,” or a holder or input location for interactions with Extension 1 (304). Additionally, the chip instance 116 may return specific information on a location for Extension 1 (304), such as a web address or uniform resource locator (URL) where a link to the extension can be found. This returned value is illustrated by 318 in the diagram.

Once that value is returned, the component runtime 112 sends its first request to Extension 1 (304), a request to identify and confirm the extension that provides the specific service identified by the chip instance 116. In particular, the component runtime 112 calls Extension 1 (304) at 322 to get a specific implementation of Extension 1 (304) that will allow the chip instance 116 to interact with and use the services provided by the extension. As illustrated in FIG. 3, the method getComponentIfImpl (or getComponentInterfaceImplementation) is used to request a specific implementation of Extension 1 (304). In response to the request at 326, Extension 1 (304) creates an Extension 1 Interface Implementation (114a) for the chip instance 116 to use when accessing and employing the functionality of Extension 1 (304). As illustrated in FIG. 3, the Extension 1 Interface Implementation (114a) implements an API interface that can be used by the chip instance 116 to access the methods associated with Extension 1 (304). At 328, Extension 1 (304) returns the generated implementation (114a) to the component runtime 112. At 330, using the on DependencyInject( ) method, the component runtime 112 sends the generated Extension 1 implementation (114a) to the chip instance 116, where it is effectively injected into the chip instance 116. Once the chip instance 116 is injected with the generated implementation, the chip instance 116 has the ability to call methods associated with Extension 1 (304) through the Extension 1 Interface Implementation (114a).

Beginning at 334, the same process to inject to Extension 1 (304) is performed with regard to Extension 2 (306). At 334, the component runtime calls the getDependencyUsage( ) method with the parameter “Extension 2”, or the second extension listed in the chip definition. At 338, the relevant information for Extension 2 (304) is returned by the chip instance 116 as was provided for Extension 1 (306) in 318. In steps 342, 346, and 350, the component runtime 112 requests and receives, and Extension 2 creates, the Extension 2 Interface Implementation (114b). At 354, the component runtime 112 injects the implemented interface of Extension 2 into the chip instance 116, providing the chip instance 116 with the access to the operations defined in Extension 2 (306) via the Extension 2 API interface.

At this point, the chip instance 116 illustrated in FIG. 3 is considered fully injected, and may call methods associated with either of Extension 1 or Extension 2 to use their functionality for the chip instance's purposes. As illustrated, at 358 the chip instance 116 calls a particular method associated with Extension 2 (306) via the Extension 2 Interface Implementation (114b), and at 362 calls a particular method associated with Extension 1 (304) via the Extension 1 Interface Implementation (114a). In this example, the functionality of both extensions is now injected in, or available to, the chip instance 116 as required or requested in the chip instance's associated chip definition.

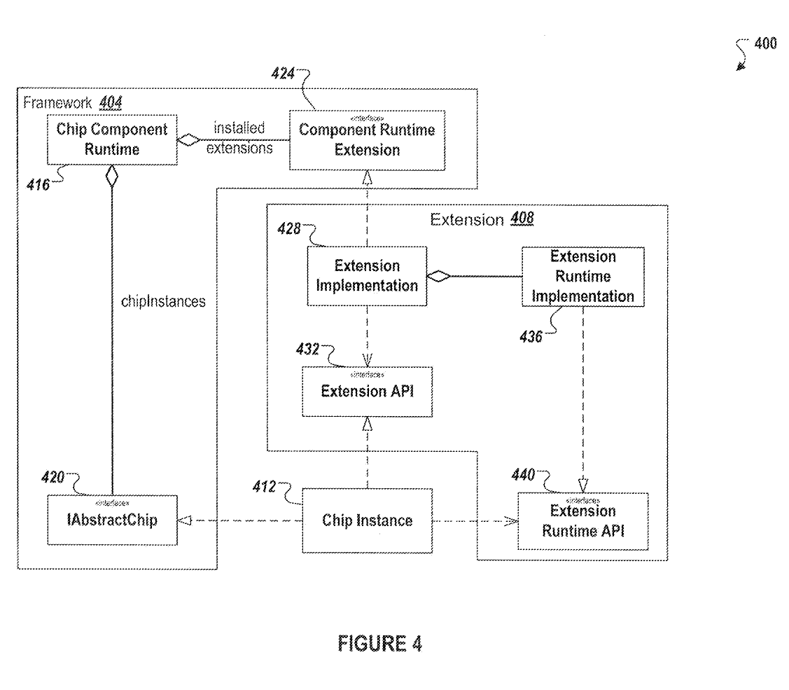

FIG. 4 is a block diagram illustrating one example configuration of a chip component model used for enabling an extensible plug-in architecture as described in various implementations above. The chip component model 400 illustrates a programming model for chip implementations as described herein. The framework 404 enforces a strict separation between the chip definition (or chip metadata) and the specific chip implementations. As previously described, the chip definition may be provided as an XML document, as well as any other suitable document or format. The chip definition's lifecycle is independent from the lifecycle of an implemented chip or chip instance. In other words, the chip implementation and the chip definition can be independently deployed in particular implementations, as well as deployed in an integrated fashion.

In general, the primary aspect of the framework 404 is the UI composition (or web UI framework) that allows for the content and visualization of the various chips to be displayed together. Thus, the chip model is primarily a programming model to expose the UI piece or content associated with a particular chip instance. Each chip instance 412 interacts with the framework 404 by consuming runtime services from one or more extensions 408 or, in some instances, providing implementations of interfaces as defined in the framework 404.

The framework 404 serves a variety of scenarios and use cases. In general, the scenarios are characterized by a varying set of available runtime services (i.e., extensions), chips, adapters, and other relevant components. The chips (and their respective chip instances) are the main building blocks of the chip model, and are meant to be reusable between scenarios to the greatest extent possible. As previously described, however, not all chips are able to run in all scenarios, as the chip definition declares certain extensions as necessary for the chip to perform as required. To determine if a chip is executable in a particular scenario or implementation, the chip component runtime 416 of the framework 404 determines whether the extensions 408 identified in the particular chip's chip definition are available. When the required extensions 408 are available in the scenario, the chip component runtime 416 injects extension runtime implementations 436 into the chip instance 412 using a method of dependency injection, such as that illustrated in FIG. 3.

With regard to the chip instance itself, each chip instance 412 implements an IAbstractChip interface 420 that provides the chip instance 412 and the chip component runtime 416 to communicate. Once the chip instance 412 appropriately implements the IAbstractChip interface 420, the chip component runtime 416 of the framework 404 can be used to manage the lifecycle functionality of the chip instance 412, as well as to allow the chip component runtime 416 the ability to associate the appropriate extensions 408 and extension runtime implementations 436 with the chip instance 412.

As illustrated, the chip component runtime 416 can handle or direct a plurality of chip instances 412 through the IAbstractChip interface 420, in addition to managing a plurality of extensions 408 through the component runtime extension interface 424. In general, the component runtime extension interface 424 monitors the various extensions 408 used in the scenario. As illustrated, each extension 408 implements the component runtime extension 424, which again allows the chip component runtime 416 to manage the lifecycle functionality of each extension 408, as well as to provide communications and links to the other chip instances 412 and extensions 408. Further, the component runtime extension interface 424 provides a component runtime view on the various extensions 408 associated with the model, as well as a listing of the methods and functionality each extension 408 exposes.

The extension implementation 428 represents an actual implementation of a particular extension 408. By implementing the component runtime extension 424, the extension implementation 428 can supply the services of the associated extension 408 to multiple chip instances 412 within the model 400, as well as other extensions 408 that request or implement the functionality of other extensions 408 themselves. Further, the extension implementation 428 exposes itself to a chip instance 412 through the extension API interface 432. In other words, the functionality of the extension 408 can be accessed by the chip instance 412 after the chip instance implements the extension API 432. Also illustrated in FIG. 4 is an extension runtime implementation 436, which is an illustration that multiple implementations of a particular extension 408 can be used in one chip model 400. Each particular implementation implements an extension runtime API interface 440, again through which the chip instance 412 can access the particular functionality of a particular extension runtime implementation 436.

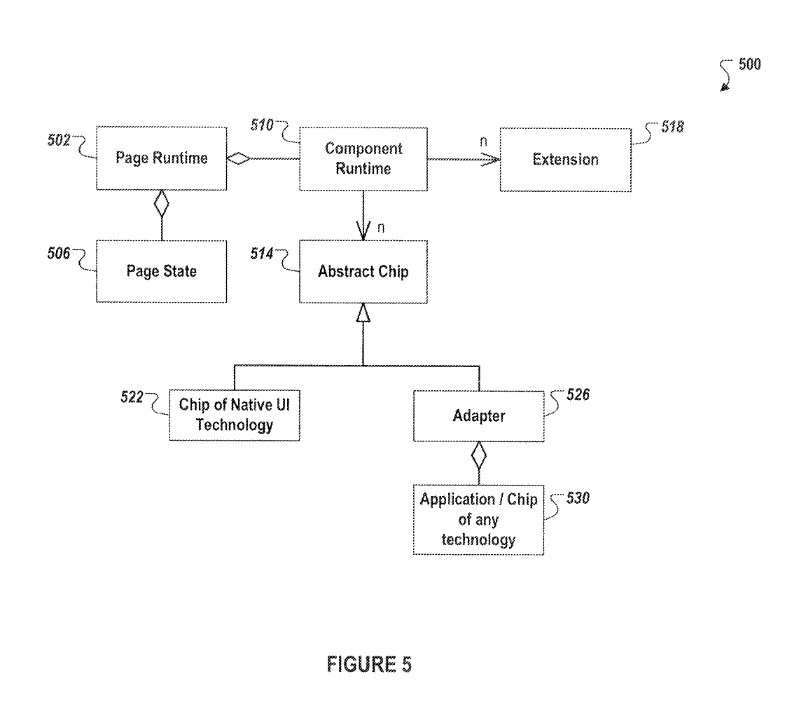

FIG. 5 is a block diagram illustrating an expanded configuration of the chip model illustrated in FIG. 4, including an illustration of how a component runtime interacts with the web UI framework. The chip model 500 includes the component runtime 510, one or more extensions 518, and one or more chips associated with the component runtime 510 via the abstract chip interface 514 as described in FIG. 4. FIG. 5 illustrates the ability of the chip model 500 to use chips 522 written in or associated with the native UI technology of a particular implementation, as well as chips 530 written in non-native UI technologies. In order to allow chips of various types to be included within a particular implementation, the chip model 500 provides one or more technology adapters 526 capable of adapting the content associated with the non-native chips 530 to that compatible with the current implementation's UI technology. Each adapter 526 complies with the requirements of the chip model 500 and implements the requirements of the abstract chip interface 514, allowing the component runtime 510 to interact with the non-native chips 530. Additionally, element 530 may also represent non-chip content that is decorated by the adapter 526 to look and behave like a chip. In other words, the adapter may provide the non-chip or non-native UI content with a descriptor and other components similar to a chip that allow the component runtime 510 to control the lifecycle of the element 530, as well as the element's connections to one or more extensions 518. For example, if the component runtime is implemented in a proprietary technology, such as SAP's Web Dynpro, then the adapter 526 may be required if the other components or chips are implemented in another UI technology, such as Java or JavaServer Faces (JSF) technologies.

As described, each chip 522 or adapted content (526 and 530) provides a snippet, or portion, of UI content. In some instances, the native UI chips 522 may be located on a different server or in a different location than the non-native items. Using the component runtime 510 as a centralized element, the chip model 500 illustrated herein allows for integration of the various and delocalized content not only on a UI level, but also on a communication level. For example, by allowing the adapter 526 to turn certain content into a compatible chip-type entity, the component runtime 510 can control and integrate the lifecycle of all elements associated with a particular page or scenario. In other words, the component runtime 510 allows the content on one server to communicate with the content from another, disparate-type of server.

Further, the component runtime 510 interacts with the web UI framework to allow the content provided by each chip to be represented visually on a web page or web-based application. As illustrated, multiple component runtimes 510 can be associated with a particular page runtime 502. The page runtime is similar to the workspace management component described above in regard to FIG. 2A. In general, the workspace management component (or page runtime 502) collects a plurality of content from multiple chips (provided by the component runtime 510) to create a mashup page or application with content from various sources. As illustrated, the page runtime 502 includes one or more page states 506. Each page state 506 is a part of the software that makes or defines a particular workspace (such as a web page) persistent. A combination of page states 506 are associated with and may comprise a single page runtime 502, and may allow the various chip (and non-chip) content to be combined into a single, visible area or UI.

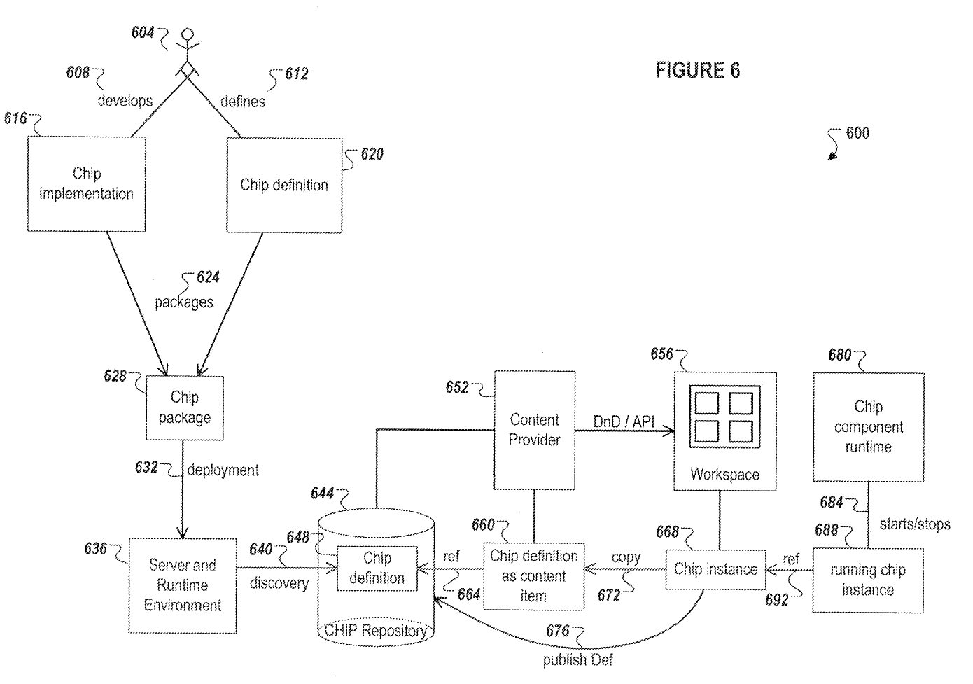

FIG. 6 is a general schematic diagram illustrating the multiple operations and interactions moving a particular chip or chip design from development to usage. Element 604 represents a chip developer, who develops (608) a chip implementation 616 and defines (612) a chip definition 620. The chip implementation 616 can be code specifically implementing a particular version of the chip, such as a Java or ABAP version of the chip for a particular environment, as well as the particular UI content associated with the chip. The chip definition 620, on the other hand, defines the one or more extensions associated with the chip, and can be provided in an XML document. The chip definition 620 defines what services (and therefore, what extensions) are required by the chip to perform its particular functionality and provides its particular UI content. Once the chip implementation 616 and the chip definition 620 are complete, the developer can package (624) the two components into a deployable chip package 628, which in turn can be deployed (632) to a customer site (636), such as the server or chip repository illustrated in FIG. 1. Generally, the above-described steps will be performed by a developer and other entities and components associated with the development of chip implementations and chip definitions.

The following steps and components are generally understood to be associated with, performed by, and/or triggered by an end user. Generally, developers are not involved after the chip package is deployed at 632. When the chip component runtime (and associated chip repository 644) starts, the new chip package may be detected or discovered (640), with a new entry or record for the chip definition (648) being added to the chip repository (644). Typically, the chip repository contains the chip definitions of all deployed chips. Further, the contents of the chip repository may be shown or displayed to a user through one or more content providers 652 (e.g., a UI associated with a web UI framework that shows specific entries 660 from the chip repository), which can then be added to a workspace 656 for use in a particular mashup scenario or implementation. As illustrated, the user can add a particular chip to the workspace via drag-and-drop functionality of the content provider 652 or indirectly through one or more API calls to the chip repository. When a particular chip is added to the workspace, a new chip instance 668 may be created within that particular workspace. The chip instance 668 refers (664) to the original chip definition 648 of the chip repository 644. When the workspace is loaded or a new chip is added, the chip component runtime 680 starts (684) all the associated chips or the new chip instance and creates a “running chip instance” 688 for each chip instance 668 in the workspace. Additionally, each chip instance 668 in the workplace may be copied (672) to the content provider 652 as a potential chip for inclusion in additional workspaces. When the running chip instance 688 is started, the relevant steps associated with the dependency injection are performed so that the running chip instance has the one or more extensions defined in the underlying chip definition available to perform the functionality associated with the chip. In some instances, a particular chip instance may be customized by the user or workspace developer to perform one or more additional or different operations than the original chip, or at least different from those that were defined in the chip definition. In those instances, the customized chip instance can be given an updated chip definition and published (676) back to the chip repository in order to allow other users to be able to view and use the new, customized chip.

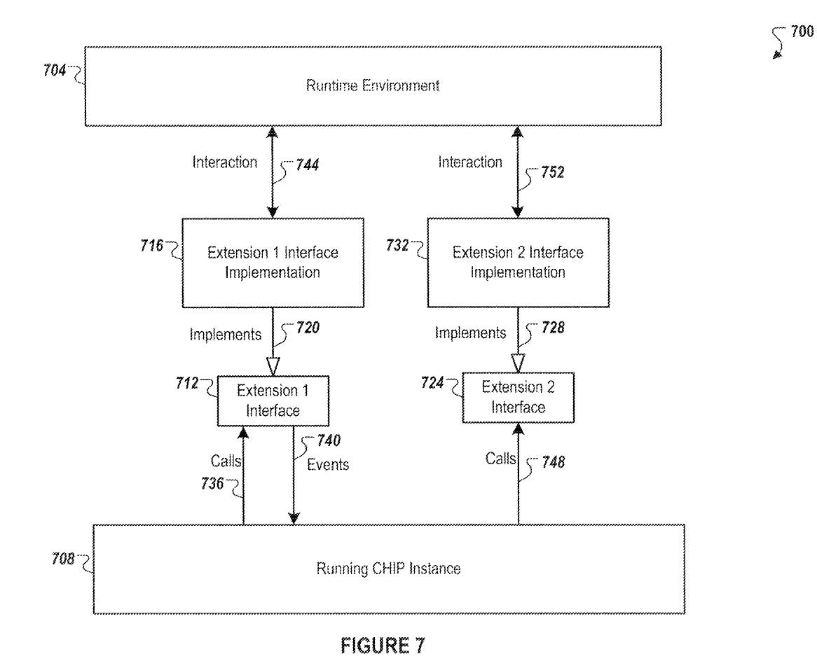

FIG. 7 is a block diagram illustrating an example of the interactions associated with a running chip instance, a runtime environment, and one or more extensions associated with the chip instance in a chip model architecture as described in the present disclosure. As illustrated, the block diagram 700 includes a running chip instance 708, two extension interfaces 712, 724, two extension interface implementations 716, 732, and the runtime environment 704. The running chip instance 708 represents a chip instance 708 executing in a particular chip model environment, wherein the chip instance 708 is associated with two extensions, extension 1 and extension 2. During the dependency injection steps performed by the component runtime (not shown), the two extensions (1 and 2) defined in the chip definition associated with the chip instance 708 were injected into the running chip instance 708. As such, the chip instance 708 is associated with the two interfaces, extension 1 interface implementation 716 and extension 2 interface implementation 732. Each extension interface implementation implements an extension interface (720 and 728), such as a related API, that allows the chip instance 708 to access and call the methods associated with the underlying extensions. For example, arrow 736 illustrates the chip instance 708 calling a one or more methods of extension 1 (and particularly, the extension 1 interface implementation 716), using the extension 1 interface 712. Using those methods, the extension 1 interface implementation 716 interacts (744) with the runtime environment 704 to perform the one or more functions associated with the running chip instance 708. In this illustration, the runtime environment 704 includes both the component runtime and the various functionality and information accessible by the implemented extensions, including the other instantiated chips included in a particular workspace or web page.

As illustrated, one or more events (740) relevant to the running chip instance 708 are provided via the extension 1 interface 712. By separating the particular chip instance 708 from the runtime environment 704, all communication between elements is performed through one or more associated extensions. In one example, a particular event 740 associated with the chip instance 708 may be an event associated with a related chip instance (other than 708), which displays or represents content related to the running chip instance 708. In that event, the running chip instance 708 may make a method call (748) to the second extension implementation (732) based on the received event 740. In general, the right side of FIG. 7 illustrates similar calls (748) and interactions (752) taking place through the extension 2 interface 724 and extension 2 interface implementation 732 as illustrated and described with regard to the first extension. As described, the running chip instance 708 can communicate with other chips, but only through the runtime environment 704. No direct communication between chips is allowed in the present chip model.

A number of embodiments of the present disclosure have been described. Nevertheless, it will be understood that various modifications may be made without departing from the spirit and scope of the present disclosure. For example, various forms of the flows shown above may be used, with steps added or removed to those illustrated, as well as steps or operations performed concurrently or in a different sequential order than that illustrated. Also, although several types of elements and components have been described, any appropriate element or component is contemplated in the present disclosure. Accordingly, other implementations are within the scope of the following claims.

What is claimed is:

1. A computer implemented method for causing one or more processors to create an extensible plug-in architecture for enterprise mashup applications, the method comprising the following steps performed by the one or more processors:
receiving a chip definition associated with a chip instance to be instantiated;
instantiating a new chip instance associated with a portion of user interface (UI) content;
determining at least one extension associated with the chip instance based on the received chip definition;
providing the chip instance access to at least one method associated with an implementation of the at least one extension; and
enabling communication between the chip instance and a runtime environment through the implemented methods of the at least one extension.

2. The method of claim 1, wherein each of the at least one extensions comprises a runtime service providing functionality to the chip instance.

3. The method of claim 1, wherein the chip definition is independent from a particular UI technology.

4. The method of claim 1, wherein providing the chip instance access to at least one method associated with an implementation of the at least one extension further comprises:
generating an API interface to the implementation of the at least one extension; and
injecting the chip instance with information associated with the API interface to the implementation of the at least one extension.

5. The method of claim 1, wherein determining the at least one extension associated with the chip instance based on the received chip definition further comprises:
analyzing the chip definition to determine at least one mandatory extension associated with the chip instance;
determining if the at least one mandatory extension is available for implementation with the chip instance; and
if the at least one mandatory extension is not available for implementation with the chip instance, ending the lifecycle of the chip instance.

6. The method of claim 1, wherein the chip definition comprises an extensible markup language (XML) document.

7. The method of claim 6, wherein the chip definition declares at least one mandatory extension and at least one optional extension associated with the chip instance.

8. The method of claim 1, wherein the chip instance renders a portion of UI content for embedding on a web page.

9. The method of claim 1, wherein the chip instance comprises an extension instance.

10. A computer program product encoded on a tangible storage medium, the product comprising computer readable instructions for causing one or more processors to perform operations comprising:
receiving a chip definition associated with a chip instance to be instantiated;
instantiating a new chip instance associated with a portion of user interface (UI) content;
determining at least one extension associated with the chip instance based on the received chip definition;
providing the chip instance access to at least one method associated with an implementation of the at least one extension; and
enabling communication between the chip instance and a runtime environment through the implemented methods of the at least one extension.

11. The computer program product of claim 10, wherein each of the at least one extensions comprises a runtime service providing functionality to the chip instance.

12. The computer program product of claim 10, wherein the chip definition is independent from a particular UI technology.

13. The computer program product of claim 10, wherein providing the chip instance access to at least one method associated with an implementation of the at least one extension further comprises:
generating an API interface to the implementation of the at least one extension; and
injecting the chip instance with information associated with the API interface to the implementation of the at least one extension.

14. The computer program product of claim 10, wherein determining the at least one extension associated with the chip instance based on the received chip definition further comprises:
analyzing the chip definition to determine at least one mandatory extension associated with the chip instance;
determining if the at least one mandatory extension is available for implementation with the chip instance; and
if the at least one mandatory extension is not available for implementation with the chip instance, ending the lifecycle of the chip instance.

15. The computer program product of claim 10, wherein the chip definition comprises an extensible markup language (XML) document.

16. The computer program product of claim 15, wherein the chip definition declares at least one mandatory extension and at least one optional extension associated with the chip instance.

17. The method of claim 10, wherein the chip instance renders a portion of UI content for embedding on a web page.

18. The method of claim 10, wherein the chip instance comprises an extension instance.
